(19) United States
(12) Patent Application Publication
(10) Pub. No.: US 2017/0057430 A1
(43) Pub. Date: Mar. 2, 2017

(54) MULTIFUNCTIONAL PANEL ASSEMBLY AND VEHICLE, ELECTRONIC PRODUCT AND BUILDING USING SAME

(71) Applicants: Sug-Whan KIM, Gyeonggi-do (KR); SphereDyne Co., Ltd., Seoul (KR)

(72) Inventor: Sug-Whan KIM, Gyeonggi-do (KR)

(21) Appl. No.: 15/307,574

(22) PCT Filed: Apr. 29, 2015
(86) PCT No.: PCT/KR2015/004292

§ 371 Date: Oct. 28, 2016

(30) Foreign Application Priority Data
Apr. 30, 2014 (KR) 10-2014-0052454

(51) Int. Cl. B60R 13/04; H02S 30/10

(52) U.S. Cl. CPC B60R 13/04; H02S 30/10; B60Y 2400/216

(57) ABSTRACT

The present invention relates to a multifunctional panel assembly, and a vehicle, an electronic product and a building using the same, and more particularly to a multifunctional panel assembly that enables panels having various functions to be selectively mounted on all items or objects each having an inside or outside mounting surface and then allows the various functions to be performed concurrently. The multifunctional panel assembly includes one or more of the functions of: 1) protecting an inside or outside surface on which a panel has been mounted, 2) providing visibility, 3) improving an aesthetic effect, 4) generating power, 5) providing a large amount of image and sound information to an observer, 6) acquiring and displaying a large amount of image and sound data, 7) maximizing the ease of mounting, and 8) restoring overall functionality without replacement or repair of an overall device.

### FIELD OF THE DISCLOSURE

The present invention relates to a multifunctional panel assembly, and a vehicle, an electronic product and a building using the same, and more particularly to a multifunctional panel assembly that enables panels having various functions to be selectively mounted on all items or objects each having an inside or outside mounting surface, such as a vehicle, a vessel, an aircraft, various types of electronic products, a building, etc., and then allows the various functions to be performed, and also to a vehicle, an electronic product, and a building using the same.

### BACKGROUND OF THE DISCLOSURE

Generally, various technical solutions for inside and outside surface decals, which are used for decoration with various designs so as to protect a corresponding outside surface, to indicate the name or grade of a product, and to improve visibility, discrimination or an aesthetic effect, have been applied onto items and objects each having a specific shape, including transportation machinery such as a vehicle, a vessel, an aircraft, etc., electronic devices, buildings, etc., for example, an outside surface of a vehicle body, a door or the like.

For example, these functions are implemented by directly applying a paint having a color different from the color of an outside surface, applying a pattern having a specific shape onto an outside surface through attachment of sticker-type film paper, or semi-permanently mounting a plastic panel.

However, when the conventional painting, the attachment of a sticker, or the semi-permanent attachment of a panel is applied, problems arise in that separation, removal and detachment are difficult after application and reuse is impossible even when separation or removal is possible. Furthermore, a problem arises in that the outside surface may be also deteriorated or damaged due to the deterioration of applied paint and sticker adhesive in the case of separation or removal.

These technical problems result in the problem of limiting the convenience of use that allows a design to be changed, modified, and attached and detached at a desired time according to the intention and need of a user.

Furthermore, a solar panel is constructed by adding electric wires into unit cells, each configured by forming a phosphorous N-type diffusion layer on phosphorous P-type silicon, through screen printing, constructing solar cells through attachment of an array of the unit cells onto a tempered glass film, coating the solar cells with a resin sealing and a protective film, and surrounding the coated solar cells with a metal frame.

Such a solar panel is used to be provided on the roof of a house or an apartment building or the outside of a transportation means, such as a vehicle, and generate power using solar light or solar heat.

However, the conventional solar panel has: the problem of being difficult to attach and detach because the conventional solar panel is permanently or semi-permanently attached to the outside surface of the vehicle body of a transportation means including a vehicle or the like; the problem of limiting decoration with various designs because the conventional solar cell is designed in a simple plane structure; the problem of suffering from difficulty in being formed to have a curvature because the conventional solar panel is configured in the form of a plane having a predetermined area or more; and the problem of replacing an overall module when part of the module has been damaged because each module of the solar panel is configured in an integrated form after electrical connection.

Meanwhile, a display device is generally used in the state of standing on a surface of a certain object, or in the state of having been attached onto a structure including a larger wall surface by means of separate equipment.

As an example, a display device provided on the inside or outside of a transportation means including a vehicle is a device embedded or attached in or onto the dashboard itself of a vehicle or at a location adjacent to the dashboard, and provides various types of analog and digital information, such as vehicle travelling information, machine information, etc., to a driver and a passenger.

Alternatively, advertisements provided on the outsides of vehicle bodies generally represent specific information and produce advertising effects by using: a method of attaching an image, transferred to a flexible object such as paper, cloth or vinyl tape, or the like, onto an outside surface of a vehicle through adhesion; a method of disposing a light source, such as a LED or the like, in a structure having a specific shape and semi-permanently mounting the structure on an outside of a vehicle (the roof or the like of the vehicle), thereby displaying desired information, such as a character and color signal or the like, in all directions; or a method of placing such a light source inside a transparent or translucent box having a specific design pattern on a surface thereof and projecting the pattern to the outside by means of light emitted from the light source.

However, the conventional display devices are limited in that: it is difficult for a user to mount such a conventional display device on an inside or outside surface of a transportation means including a vehicle; easily mountable display devices are restricted to devices having small size and low weight; a display device that has a size similar to that of the dashboard of a vehicle and can be easily attached to and detached from an inside or outside surface of a vehicle or a structure has not been implemented; and it is difficult to efficiently transfer a large analog or digital information image varying over time to an observer inside or outside a vehicle.

Meanwhile, there has not been commercialized a panel-type device that is capable of selectively or concurrently performing one or more of various functions, i.e., the functions of: protecting an inside or outside surface on which a panel has been mounted; providing visibility and discrimination; improving an aesthetic effect; generating power using received solar light: providing a large amount of image and sound information to an observer through display when required; acquiring and displaying a large amount of image and sound data; maximizing the ease of mounting; and restoring overall functionality without replacement or repair of an overall device through the replacement of only a damaged portion when part of a solar panel has been damaged or a partial function has been lost.

Furthermore, a panel assembly, including a panel having such a function convergence characteristic and a mounting mechanism, has not been applied to the surfaces of items or objects, including not only a transportation means such as a vehicle, etc. but also, for example, the bodies of various types of electronic products such as a microwave oven, etc., a wall, ceiling and partition of a building, etc.

### PRIOR ART

(Patent document 1) Korean Patent Application Publication No. 10-2006-0023352

### SUMMARY

### Technical Problem

Accordingly, the present invention is intended to overcome the above-described problems, and an object of the present invention is to: provide a multifunctional panel assembly that can protect an inside or outside surface on which a panel has been mounted, can provide visibility and discrimination, can improve an aesthetic effect, can generate power using received solar light, can provide a large amount of image and sound information to an observer through display when required, can acquire a large amount of image and sound data, can maximize the ease of mounting, and can restore overall functionality without replacement or repair of an overall device through the replacement of only a damaged portion when part of a solar panel has been damaged or a partial function has been lost: and provide a vehicle, an electronic product and a building using the same.

It will be clearly appreciated by those having ordinary knowledge based on the following description that technical problems that the present invention is intended to overcome are not limited or restricted to the above-described technical problem, but other technical problems in the art to which the present invention pertains are included in the spirit of the above-described technical problems.

### Technical Solution

In order to accomplish the above object, according to a first embodiment of the present invention, there is provided a multifunctional panel assembly, including: a multifunctional panel; a mounting surface configured such that the panel is seated thereon; a fastening unit configured to be fastened onto a fastening surface adjacent to the mounting surface; a connection portion configured to couple the panel to the fastening unit; and a grip portion provided on one end of the connection portion, and configured to grip the panel.

The fastening unit may include: an introduction hole configured such that the other end of the connection portion is introduced thereinto; and a fastening hole configured such that the other end of the connection portion introduced into the introduction hole is snap-fitted thereinto.

The connection portion may include: a flexible connection member made of an elastic or flexible material, and configured to be introduced into the introduction hole; and a fastening hook provided at the other end of the flexible connection member to be snap-fitted into the fastening hole.

The flexible connection member may be introduced into the introduction hole formed in one end surface of the fastening unit, and the fastening hook may be snap-fitted into the fastening hole formed in one surface or the other end surface of the fastening unit.

One or more of the introduction hole may be formed in one end surface of the fastening unit; the fastening hole may be formed in a side surface of the fastening unit, and the introduction hole and the fastening hole may communicate with each other so that they are inclined from one end surface of the fastening unit to the side surface of the fastening unit; and one or more of the flexible connection member may be introduced into the introduction hole, and the fastening hook may be snap-fitted into the fastening hole.

The grip portion may be provided as a clip member configured to elasticity press and grip the panel, and a mounting depression or hole into which an end of the clip member is inserted may be formed in the panel.

In order to accomplish the above object, according to a second embodiment of the present invention, there is provided a multifunctional panel assembly, including: a multifunctional panel; a mounting surface configured such that the panel is seated thereon; a pair of fastening units configured to be fastened onto a fastening surface, adjacent to the mounting surface, and the panel, respectively; and a connection portion configured to connect the pair of fastening units to each other.

Each of the fastening units may include: an introduction hole configured such that each of both ends of the connection portion is introduced thereinto; and a fastening hole configured such that each of both ends of the connection portion introduced into the introduction hole is snap-fitted thereinto.

The connection portion may include: a flexible connection member made of an elastic or flexible material, and configured to be introduced into the introduction holes; and fastening hooks provided at both ends of the flexible connection member to be snap-fitted into the fastening holes.

The flexible connection member may be introduced into the introduction hole formed in one end surface of each of the fastening units, and each of the fastening hooks may be snap-fitted into the fastening hole formed in one surface or the other end surface of each of the fastening units.

Each of the introduction holes may include at least one introduction hole formed in one end surface of the fastening unit; each of the fastening holes may be formed in a side surface of each of the fastening units, and the introduction hole and the fastening hole may communicate with each other so that they are inclined from the one end surface of the fastening unit to the side surface of the fastening unit; and one or more of the flexible connection member may be introduced into the introduction holes, and the fastening hooks may be snap-fitted into the fastening holes.

In order to accomplish the above object, according to a third embodiment of the present invention, there is provided a multifunctional panel assembly, including: a multifunctional panel; a mounting surface configured such that the panel is seated thereon; a first fastening member provided on an end of the panel; and a second fastening member provided on the mounting surface, and configured such that the first fastening member is fastened thereto so as to couple the panel onto the mounting surface.

The second fastening member may include at least one fastening pin coupled in a mounting depression or hole formed in the mounting surface; and the first fastening member may include a first fastening plate separably provided in a cutaway depression formed at an end of the panel, and a clip hook provided at one end of the first fastening plate and configured to be hooked around the fastening pin.

The first fastening member may further include an elastic member provided at the other end of the first fastening plate to connect the first fastening plate and one end of the cutaway depression to each other.

The first fastening member may further include a first rotating shaft provided at the other end of the first fastening plate to rotatably couple the first fastening plate to one end of the cutaway depression.

The first fastening member may include a first clip hook provided at an end of the panel; and the second fastening member may include: a second fastening plate separably provided in a cutaway depression formed at an end of the mounting surface, provided with at least one opening so that the first clip hook is hooked into the at least one opening, and provided with a second fastening pin coupled in the opening; a second rotating shaft provided at the other end of the second fastening plate so as to rotatably couple the second fastening plate into one end of the cutaway depression; and a second clip hook configured to be hooked around a first fastening pin coupled in the other end of the cutaway depression.

In order to accomplish the above object, according to a fourth embodiment of the present invention, there is provided a multifunctional panel assembly, including: a multifunctional panel: a mounting surface configured such that the panel is seated thereon; a fastening unit provided at an end of the panel, and configured to include a fastening member, a hook member, and a protrusion member, a plurality of open portions provided in the mounting surface, and configured such that the fastening unit is mounted thereinto so as to couple the panel onto the mounting surface; and a fastening rib configured to guide the fastening unit that is introduced into the open portions.

The fastening member may be made of an elastic or flexible material, the hook member may be introduced and hooked into one of the open portions, and the protrusion member may be inserted into one of the open portions.

In the multifunctional panel assembly according to any one of the first to fourth embodiments, at least one surface of the multifunctional panel may be provided with a decal formed by printing or transferring a design of a desired character or shape.

At least one surface of the multifunctional panel may be provided with a display device configured to acquire and display an image and a sound.

At least one surface of the multifunctional panel may be provided with a solar cell module.

The solar cell module may include: a plurality of solar cells; a grid-type frame configured to provide a plurality of mounting spaces into which the solar cells are inserted and fastened, respectively; and connecting electric wires embedded in respective partitions of the frame defining the mounting spaces, and connected to terminals provided in the solar cells.

The solar cell module may further include: first hooks provided at both ends of each of the solar cells, and second hooks provided at both ends of each of the partitions, and configured to be hooked to the first hooks.

There is provided a vehicle, wherein the multifunctional panel assembly constitutes at least one of an interior surface and an exterior surface.

There is provided an electronic device, wherein the multifunctional panel assembly constitutes at least one of an interior surface and an exterior surface.

There is provided a building, wherein the multifunctional panel assembly constitutes at least one of an interior surface and an exterior surface.

### Advantageous Effects

According to the present invention, there are the advantages of protecting an inside or outside surface on which a panel has been mounted, providing visibility and discrimination, improving an aesthetic effect, generating power using received solar light, providing a large amount of image and sound information to an observer through display when required, acquiring a large amount of image and sound data, maximizing the ease of mounting, and restoring overall functionality without replacement or repair of an overall device through the replacement of only a damaged portion when part of a solar panel has been damaged or a partial function has been lost.

Furthermore, there is the advantage of easily implementing one or more of the functions at the time and location desired by a user without a need for special or expensive additional equipment.

Furthermore, an example of an advantage according to the present invention is described by using an application to a vehicle. When the multifunctional panel is mounted by using a side door of a vehicle as a mounting surface, image information acquired by the sensor unit of a right display panel may be displayed on a left display panel and, simultaneously image information acquired by the sensor unit of the left display panel may be displayed on the right display panel, from the standpoint of the driver. When such display panels are provided throughout a vehicle and image information acquired in a specific direction is displayed on a display panel in the opposite direction, an advantage arises in that a transparent vehicle body that is invisible to the eyes of an external observer can be implemented.

Furthermore, according to the present invention, there is the advantage of easily converting a general vehicle body into a visually transparent vehicle body or inversely converting the visually transparent vehicle body into the general vehicle body.

### BRIEF DESCRIPTION OF THE DRAWINGS

FIG. 1 (a) and (b) are diagrams illustrating states in which a multifunctional panel assembly according to the present invention is mounted on outside and inside surfaces of a vehicle, respectively;

FIGS. 2 (a) and (b) are diagrams illustrating examples of the mounting structure of the multifunctional panel assembly according to the present invention;

FIG. 3 is a perspective view showing a multifunctional panel assembly according to a first embodiment of the present invention:

FIG. 4 is a diagram illustrating an example of a fastening surface onto which the fastening unit of the multifunctional panel assembly according to the first embodiment of the present invention is fastened;

FIG. 5 is a perspective view showing the fastening unit of the multifunctional panel assembly according to the first embodiment of the present invention;

FIG. 6 is a perspective view showing a multifunctional panel assembly according to a first embodiment of the present invention;

FIG. 7 is a perspective view showing the fastening unit of a multifunctional panel assembly according to a first embodiment of the present invention;

FIG. 8 is a perspective view showing the multifunctional panel assembly according to the first embodiment of the present invention;

FIG. 9 is a perspective view showing the grip portion of a multifunctional panel assembly according to a first embodiment of the present invention;

FIG. 10 is a perspective view showing a multifunctional panel assembly according to a second embodiment of the present invention;

FIG. 11 is a perspective view showing the panel of a multifunctional panel assembly according to a third embodiment of the present invention;

FIG. 12 is a perspective view showing the mounting surface of the multifunctional panel assembly according to the third embodiment of the present invention;

FIGS. 13 and 14 are perspective views showing the fastening structure of the panel and mounting surface of the multifunctional panel assembly according to the third embodiment of the present invention;

FIG. 15 is a diagram illustrating an example in which the mounting surface of a multifunctional panel assembly according to a fourth embodiment of the present invention is a side surface of a vehicle body;

FIG. 16 is a diagram showing the panel of the multifunctional panel assembly according to the fourth embodiment of the present invention;

FIG. 17 shows sectional plan views showing various fastening structures of the mounting surface and panel of the multifunctional panel assembly according to the fourth embodiment of the present invention;

FIG. 18 is a perspective view showing a case where panels of a multifunctional panel assembly according to the present invention include display devices;

FIG. 19 is a sectional side view showing a case where panels of a panel assembly according to the present invention include solar cell modules; and

FIG. 20 shows sectional side views schematically showing the solar cell mounting structure of the solar cell module shown in FIG. 19.

### DESCRIPTION OF REFERENCE NUMERALS OF THE DRAWINGS

110: panel
112: mounting depression or mounting hole
120: mounting surface
130: fastening unit
132: introduction hole
134: fastening hole
136: communication space
138: attachment member
140: connection portion
142: flexible connection member
144: fastening hook
150: grip portion
152: clip member
210: panel
220: mounting surface
230: fastening unit
232: introduction hole
234: fastening hole
240: connection portion
242: flexible connection member
244: fastening hook
310: panel
312: cutaway depression
320: mounting surface
322: mounting depression or mounting hole
324: cutaway depression
326: first fastening pin
328: second fastening pin
331: first fastening plate
332: clip hook
333: elastic member
334: first rotating shaft
335: first clip hook
341: fastening pin
342: second fastening plate
343: opening
344: second rotating shaft
345: second clip hook
420: display device
430: solar cell module
431: solar cell
431a: terminal
433: frame
433a: mounting space
433b: partition
435: connecting electric wire
437: first hook
439: second hook
440: battery
500: panel
510: fastening unit
512: fastening member
514: hook member
516: protrusion member
520: open portion
522: fastening rib

### DETAILED DESCRIPTION

Embodiments according to the present invention will be described in detail below with reference to the accompanying drawings. In this process, the sizes, shapes, etc. of components shown in the drawings may be exaggerated for clarity and convenience of description. Furthermore, the meanings of the terms particularly defined by considering the configuration and operation of the present invention may vary depending on the intention and practice of a user or an operator. These terms should be defined based on the content of the overall specification. Furthermore, the spirit of the present invention is not limited to presented embodiments. Those skilled in the art who understand the technical spirit of the present invention may easily practice other embodiments within the range of the same technical spirit. It is apparent that the other embodiments also fall within the scope of the present invention.

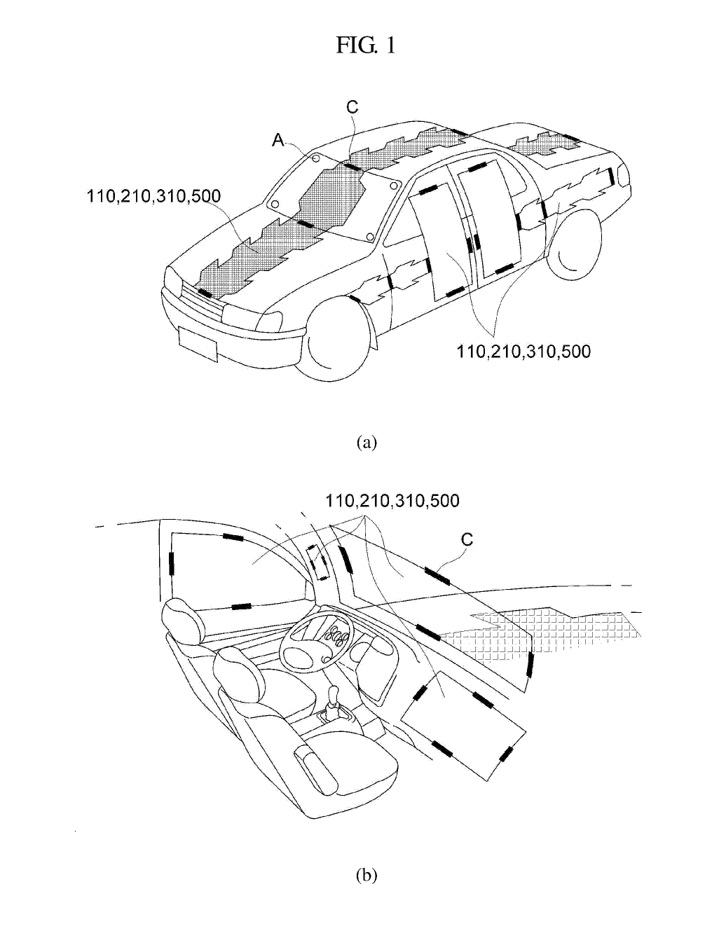

FIGS. 1a and 1b are diagrams illustrating states in which a multifunctional panel assembly according to the present invention is mounted on outside and inside surfaces of a vehicle, respectively. In FIGS. 1a and 1b, reference symbol “C” designates an example of the portion where the multifunctional panel assembly is mounted. In connection with the definition of a term used in the following description, multifunctional panels 110, 210, 310 and 500 refer to panels each including at least one of a decal, a display device 420, and a solar cell module 430 on at least one surface thereof.

Referring to FIG. 1 (a), multifunctional panels 110, 210, 310 and 500 each provided with at least one of a decal formed by printing or transferring a design of a desired character or shape, a display device configured to display an image, and a solar cell module are mounted on the outside surface of a vehicle. In this case, a mounting method is at least one of the mounting structure of a multifunctional panel assembly according to the present invention, welding, screw, bolt and nut fitting, an elastic clip, Velcro, an adhesive tape, and an adhesive pad.

Meanwhile, the multifunctional panels 110, 210, 310 and 500 that are mounted on the front and rear windshields of a vehicle body are equipped with sensors A configured to detect an image, a sound, etc. It is preferred that acquired image and sound data is transmitted and displayed on the multifunctional panels mounted on the inside and outside of a vehicle and provided with display devices 420, so that an occupant inside the vehicle and a user outside the vehicle can become aware of visual and sound information inside or outside the vehicle in real time.

Referring to FIG. 1 (b), the multifunctional panels 110, 210, 310 and 500 provided with display devices are each mounted by using at least one of all the surfaces of a vehicle body, including front and rear windshields, front, rear, left and right windows, a vehicle instrument panel, pillar surfaces, a ceiling, and a floor inside a vehicle, as a mounting surface by means of at least one method of the mounting structure of the multifunctional panel assembly according to the present invention, welding, screw, bolt and nut fitting, an elastic clip, Velcro, an adhesive tape, and an adhesive pad.

In this case, image and sound sensors A may be contained, for example, embedded, inside the panels 110, 210, 310 and 500 each mounted on an outside mounting surface, and thus information acquired from the image and sound sensors A may be displayed on the multifunctional panels 110, 210, 310 and 500 provided with display devices inside the vehicle.

Accordingly, there is achieved the effect of reserving the convenience of driving of a vehicle even when existing rear-view mirrors attached onto vehicle doors and a rear-view mirror attached onto a portion above the front windshield of a vehicle are moved from a vehicle body or even when the front and rear windshields and all glass windows of a vehicle are replaced with the multifunctional panels 110, 210, 310 and 500 including the display devices 420.

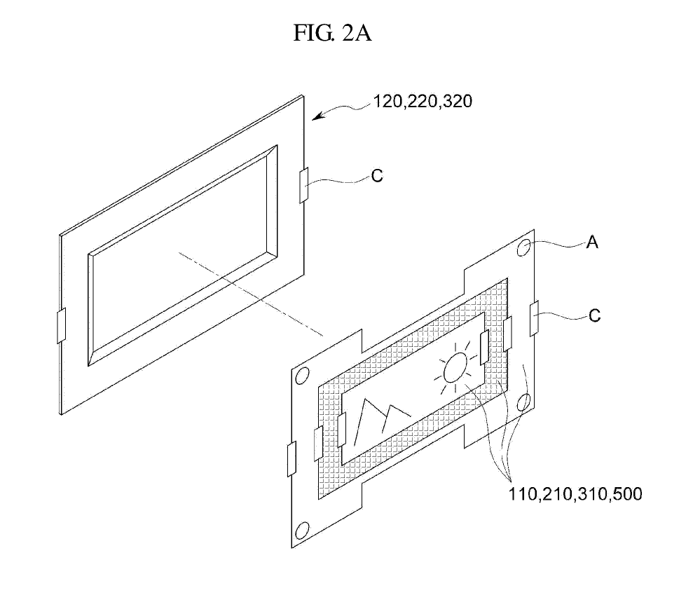

FIGS. 2a and 2b are diagrams illustrating examples of the mounting structure of the multifunctional panel assembly according to the present invention. In FIGS. 2a and 2b, reference symbol “C” designates an example of the portion where the multifunctional panel assembly is mounted. The configuration of the multifunctional panels 110, 210, 310 and 500 constituting the present invention is illustrated.

That is, in a preferred embodiment, each of the multifunctional panels 110, 210, 310 and 500 provided with the display devices 420 is disposed at a center, and each of the multifunctional panels 110, 210, 310 and 500 provided with solar cell modules 430 is disposed on a surrounding portion or a rear surface. These panels are mounted by using the mounting structure of the multifunctional panel assembly according to the present invention.

Furthermore, each of the multifunctional panels 110, 210, 310 and 500 provided with the solar cell modules 430 is mounted on each of the multifunctional panels 110, 210, 310 and 500 provided with decals, each formed by printing or transferring a desired character or shape design, by using the mounting structure of the multifunctional panel assembly according to the present invention, thereby forming each of the multifunctional panels 110, 210, 310 and 500.

Each of the multifunctional panels 110, 210, 310 and 500 are mounted on a mounting surface or a frame having a depressed portion, as shown in FIG. 2 (a) or (b). In connection with the definition of a term used herein, the mounting surface and the frame are all defined as mounting surfaces 120, 220 and 320.

The specific structure and function of the multifunctional panel assembly according to the present invention will be described in detail below.

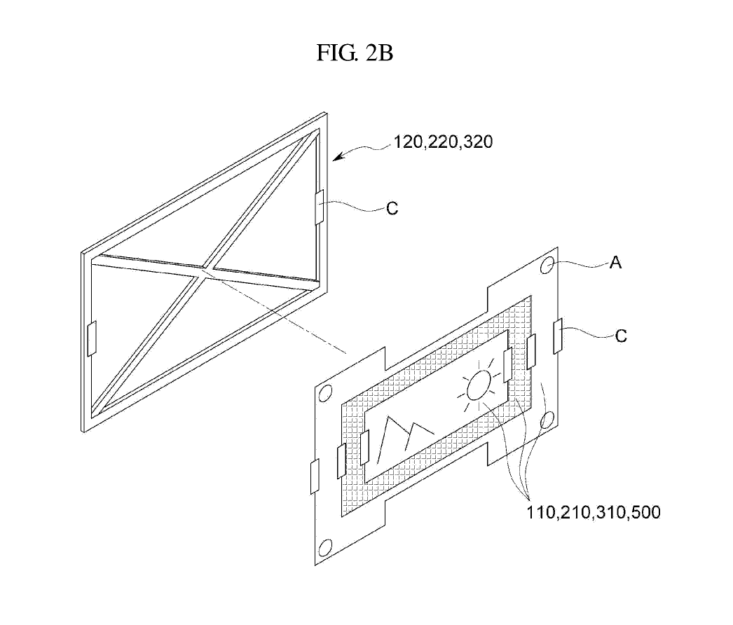

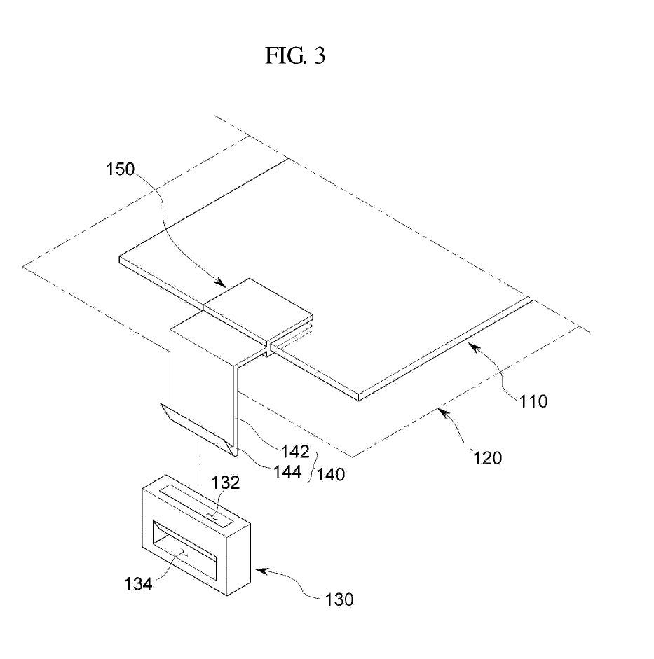

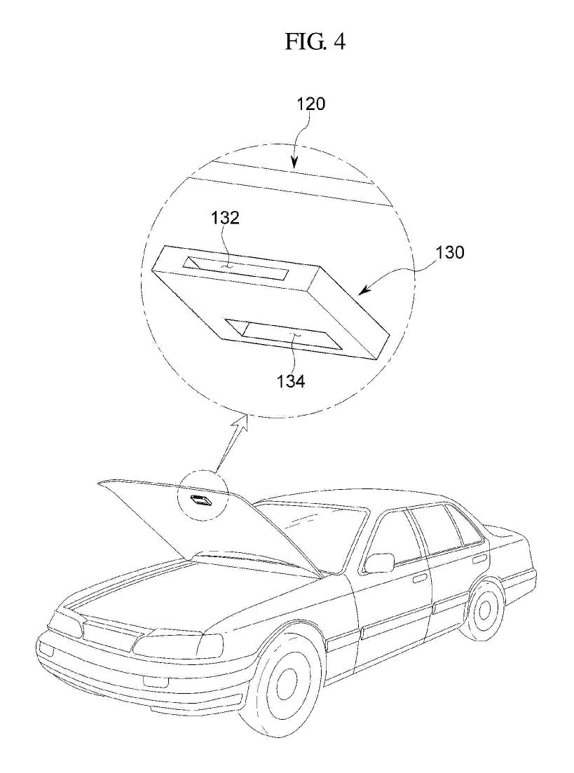

FIG. 3 is a perspective view showing a multifunctional panel assembly according to a first embodiment of the present invention, FIG. 4 is a diagram illustrating an example of a fastening surface onto which the fastening unit of the multifunctional panel assembly according to the first embodiment of the present invention is fastened, and FIG. 5 is a perspective view showing the fastening unit of the multifunctional panel assembly according to the first embodiment of the present invention. The specific configuration and fastening structure of the multifunctional panel assembly will be described in detail with reference to FIGS. 3 to 5.

Referring to FIG. 3, the multifunctional panel assembly is used to mount a predetermined panel, provided with a decal, a display device 420 or a solar cell module 430, on all items and objects each having an outside or inside mounting surface, such as a vehicle, a vessel, an aircraft, an electronic product, a building, etc. The multifunctional panel assembly includes a panel 110, a mounting surface 120, a fastening unit 130, a connection portion 140, and a grip portion 150. In this case, the mounting surface 120 may be configured as a frame.

Although an example in which the mounting surface 120 of the panel 110 is a corresponding portion of the vehicle body of a vehicle will be described below, this is merely an example, and the content of the present invention is not limited by a specific example of the mounting surface 120.

The panel 110 may have various functions, such as a design function (including visibility, discrimination, aesthetic appearance, painting, and protection functions), a solar cell function (including a power generation function), a display function (including image and sound information acquisition and display functions), etc. These functions are selectively used by a user. Furthermore, the mounting surface 120 provides a surface onto which the panel 110 is seated, fastened, and mounted.

The fastening unit 130 is fastened onto a fastening surface adjacent to the mounting surface 120. For example, when the mounting surface 120 is set to an outside surface of the hood of a vehicle, as shown in FIG. 4, the fastening surface may correspond to an inside surface of the hood of the vehicle.

In this case, the fastening surface may be set to any surface as long as the surface allows the panel 110 to be seated and mounted on the mounting surface 120. The content of the present invention is not limited by the location of the fastening surface.

More specifically, the fastening unit 130 is configured to include an introduction hole 132 and a fastening hole 134. The introduction hole 132 and the fastening hole 134 communicate with each other through a communication space 136.

That is, the introduction hole 132 is opened in the upper end surface of the fastening unit 130 in order to allow the other end of the connection portion 140 to be introduced, and the fastening hole 134 is opened in any one of one surface, lower end surface and both side surfaces of the fastening unit 130 in order to allow the other end of the connection portion 140 introduced into the introduction hole 132 to be snap-fitted thereinto.

FIGS. 3 to 5 show examples in which the fastening hole 134 is opened in one surface, i.e., the front surface, of the fastening unit 130.

Furthermore, at least one attachment member 138 is provided on the rear surface of the fastening unit 130, as shown in FIG. 3. The fastening unit 130 may be attached or fastened onto the fastening surface by the attachment member 138.

In this case, the attachment member 138 may be a fastening member, such as an adhesive pad, Velcro, a screw, a bolt, a nut, a welding material, or the like. Any element or method may be used as long as the element or method can fasten the fastening unit 130 onto the fastening surface. The content of the present invention is not limited by the type of attachment member 138.

The connection portion 140 is used to connect the panel 110 to the fastening unit 130. More specifically, the connection portion 140 includes a flexible connection member 142 having the characteristic of exhibiting some elasticity and flexibility and thus being restored when being bent, and a fastening hook 144.

The flexible connection member 142 is made of an elastic and flexible material including a synthetic resin, a metal alloy or the like so that it can be bent in various directions, and is introduced into the introduction hole 132. The fastening hook 144 is provided at the other end of the flexible connection member 142 so that it can be snap-fitted into the fastening hole 134. In particular, the fastening hook 144 is configured to have elasticity. Accordingly, when the fastening hook 144 is inserted into the introduction hole 132, the shape thereof slides through the communication space 136, and the shape of the fastening hole 134 is restored, thereby implementing snap fitting.

Referring to FIGS. 3 to 5, since the fastening hole 134 is opened in one surface, i.e., the front surface of the fastening unit 130 as described above, the flexible connection member 142 is introduced into the introduction hole 132 formed in the upper end surface of the fastening unit 130, and the fastening hook 144 is snap-fitted into the fastening hole 134 formed in one surface of the fastening unit 130.

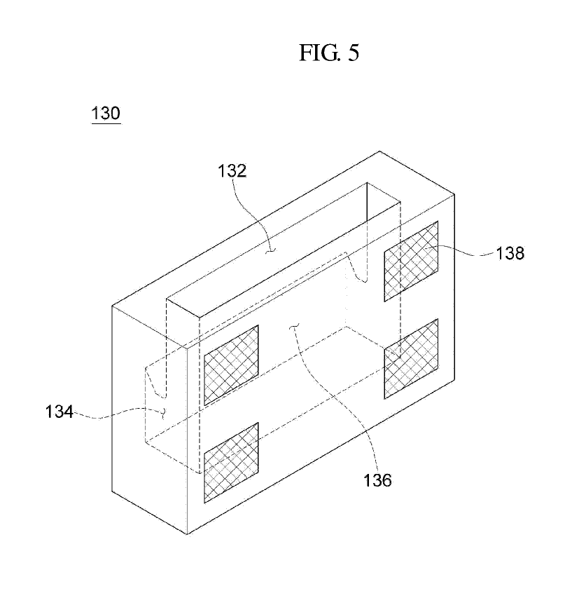

Furthermore, FIG. 6 is a perspective view showing a multifunctional panel assembly according to a first embodiment of the present invention, and illustrates an example in which a fastening hole 134 is opened in the lower end surface of a fastening unit 130.

Accordingly, according to the present embodiment, a flexible connection member 142 is introduced into an introduction hole 132 formed in the upper end surface of a fastening unit 130, and a fastening hook 144 is snap-fitted into a fastening hole 134 formed in the lower end surface of the fastening unit 130.

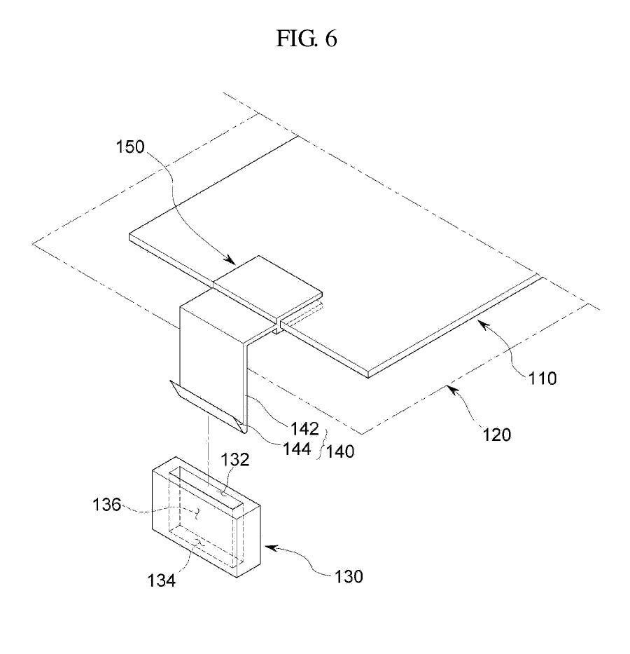

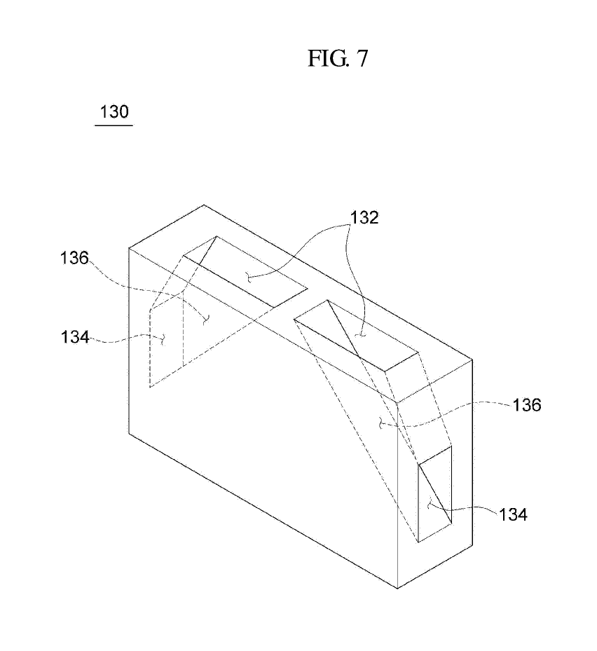

Meanwhile, FIG. 7 is a perspective view showing the fastening unit of a multifunctional panel assembly according to a first embodiment of the present invention, and FIG. 8 is a perspective view showing the multifunctional panel assembly according to the first embodiment of the present invention. These drawings illustrate an example in which a pair of introduction holes 132 are formed in the upper end surface of a fastening unit 130 and fastening holes 134 are opened in both side surfaces of the fastening unit 130.

Furthermore, in accordance with this, a pair of flexible connection members 142 are provided and introduced into the pair of introduction holes 132, and fastening hooks 144 are snap-fitted into the fastening holes 134.

In this case, the introduction holes 132 and the fastening holes 134 communicate with each other so that they are inclined downward from the upper end surface of the fastening unit 130 to both side surfaces of the fastening unit 130. That is, since the bottom surface of the communication space 136 is formed to be inclined downward, the flexible connection members 142 are naturally moved to the fastening holes 134 after being introduced into the introduction holes 132, and thus the fastening hooks 144 can be easily snap-fitted into the fastening holes 134.

In this case, a plurality of introduction holes 132, a plurality of fastening holes 134, and a plurality of communication spaces 136 may be formed in the fastening unit 130.

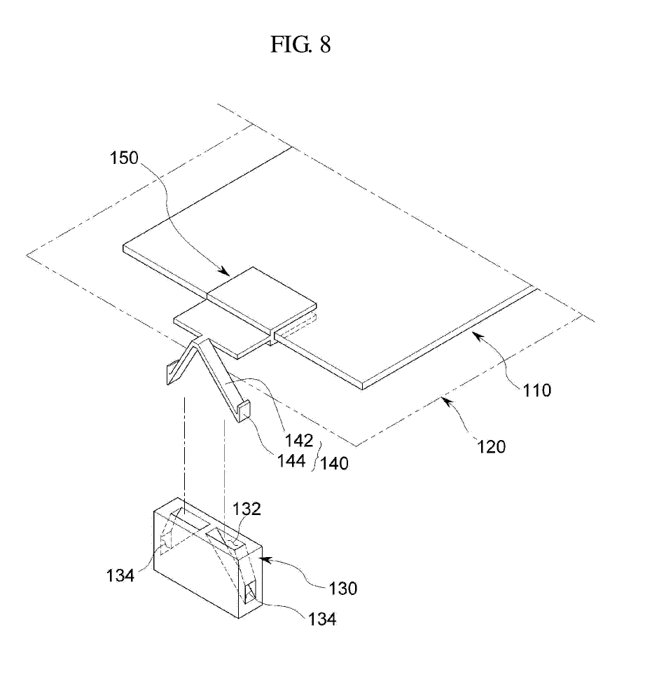

FIG. 9 is a perspective view showing the grip portion of a multifunctional panel assembly according to a first embodiment of the present invention. The grip portion 150 is provided at one end of the connection portion 140 so as to grip a panel 110, and is provided as a clip member 152 so as to elasticity press and grip the panel 110.

Furthermore, a mounting depression or mounting hole 112 is formed in the panel 110. The mounting depression or mounting hole 112 is intended to provide a space into which an end of the clip member 152 is inserted and fastened, thereby maximizing the coupling force of the grip portion 150 and the panel 110.

In this case, the mounting depression 112 is formed in the panel 110 to have a predetermined depth, and is formed in at least one surface of the panel 110. Furthermore, the mounting hole 112 is formed to pass through the panel 110.

According to the first embodiment of the present invention, the mounting depression or mounting hole 112 may be selectively formed to have any one of various shapes, such as various depths, various lengths, etc., depending on the level of the elastic pressing force or the like of the clip member 152.

Furthermore, the grip portion 150 may be implemented on the panel 110 or a mounting surface 120 by using various types of attachment members 138, such as welding, bolt and nut fitting, an adhesive tape, an adhesive pad, Velcro, an adhesive, a hook and a clip, screw fitting, etc. Accordingly, the content of the present invention is not limited by a specific attachment method.

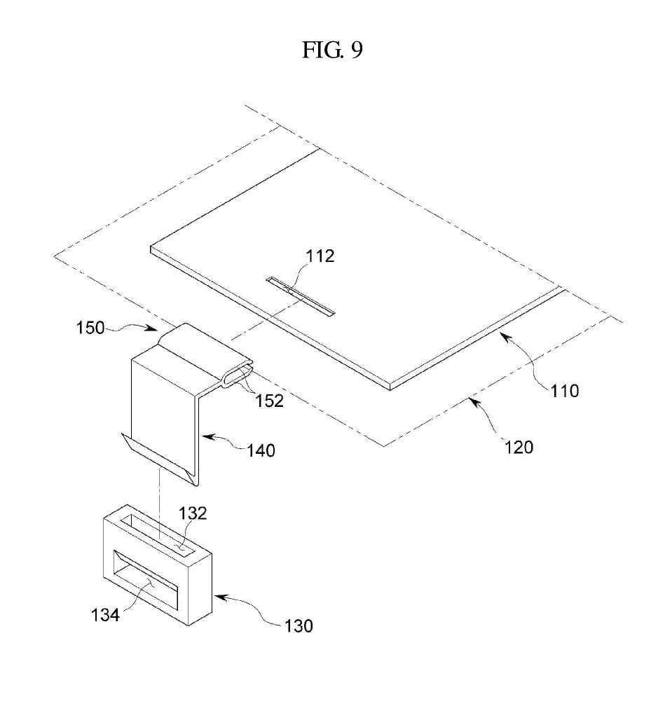

FIG. 10 is a perspective view showing a multifunctional panel assembly according to a second embodiment of the present invention. Referring to FIG. 10, the specific configuration and fastening structure of the multifunctional panel assembly will be described in detail. Descriptions of structures identical to those of the multifunctional panel assembly according to the above-described first embodiment are omitted.

Referring to FIG. 10, the panel assembly according to the second embodiment of the present invention is configured to include a panel 210, a mounting surface 220, a fastening unit 230, and a connection portion 240. In the multifunctional panel assembly of the first embodiment, the grip portion 150 is provided at one end of the flexible connection member 142, and the fastening hook 144 is provided at the other end thereof. In contrast, in the multifunctional panel assembly of the second embodiment, fastening hooks 244 are respectively provided at both ends of a flexible connection member 242 constituting part of the connection portion 240.

That is, according to the second embodiment of the present invention, a pair of fastening units 230 are provided to be fastened onto a fastening surface, adjacent to the mounting surface 220, and the panel 210, respectively. The connection portion 240 connects the pair of fastening units 230 to each other.

Each of the fastening units 230 includes an introduction hole 232 and a fastening hole 234, as described above. Both ends of the flexible connection member 242 are introduced into the introduction holes 232, and the fastening hooks 244 provided at both ends of the flexible connection member 244 are snap-fitted into the fastening holes 234, respectively.

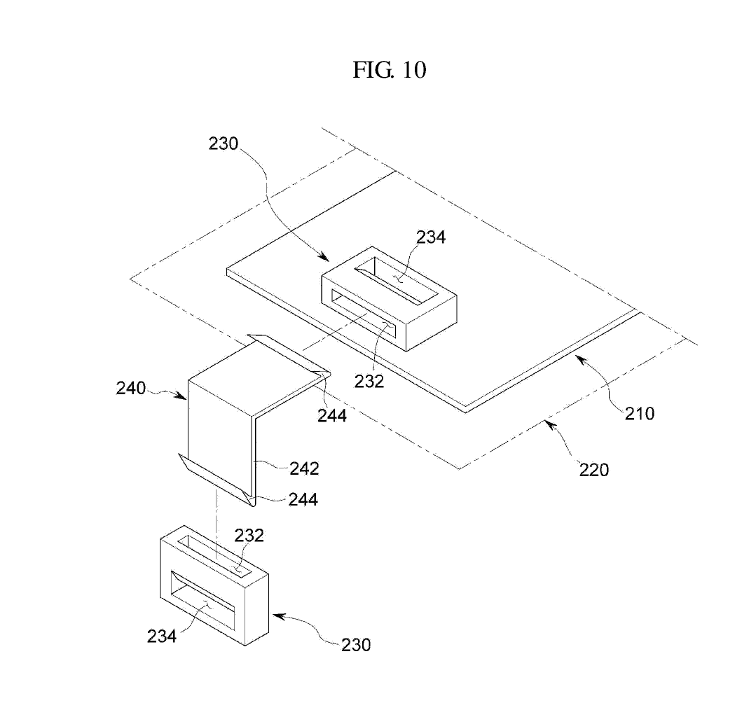

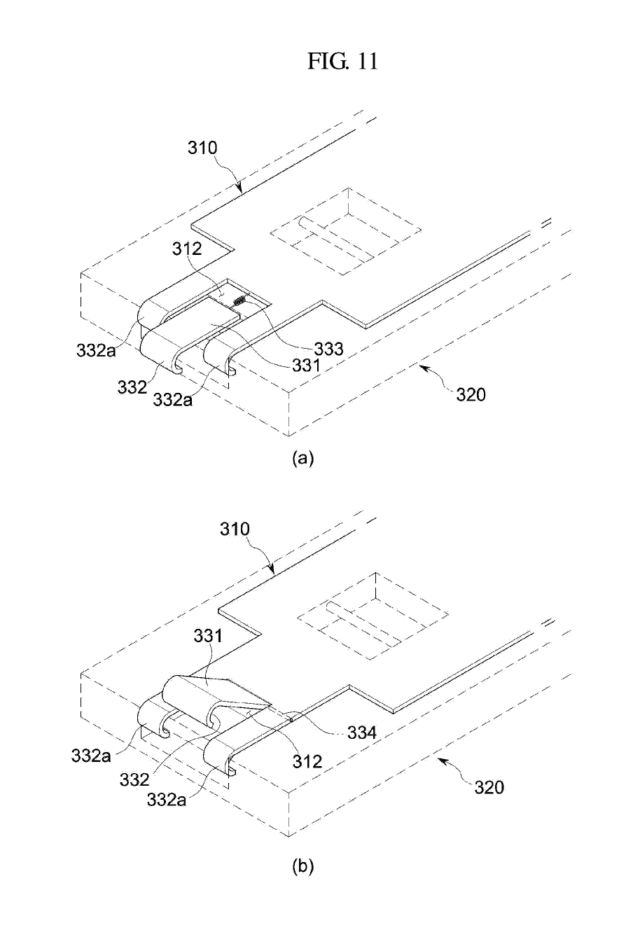

FIG. 11 is a perspective view showing the panel of a multifunctional panel assembly according to a third embodiment of the present invention, and FIG. 12 is a perspective view showing the mounting surface of the multifunctional panel assembly according to the third embodiment of the present invention. Referring to FIGS. 11 and 12, the specific configuration and fastening structure of the multifunctional panel assembly will be described in detail below.

Referring to FIGS. 11 and 12, the panel assembly is configured to include a panel 310, a mounting surface 320, a first fastening member, and a second fastening member. As described above, the panel 310 has various functions, such as a decal, a solar cell, a display, etc. The mounting surface 320 provides a surface onto which the panel 310 is seated and fastened.

The first fastening member is provided at an end of the panel 310, and the second fastening member is provided on the mounting surface 320 and fastened with the first fastening member, thereby coupling and fastening the panel 310 to the mounting surface 320.

More specifically, the first fastening member includes a first fastening plate 331 and a clip hook 332. The first fastening plate 331 is provided to be separable from a cutaway depression 312 formed at an end of the panel 310 through the action of an elastic member 333 or first rotating shaft 334. The clip hook 332 is provided at one end of the first fastening plate 331.

Auxiliary clip hooks 332a disposed on both sides of the clip hook 332 are provided at an end of the panel 310. The auxiliary clip hooks 332a enhance the coupling force of the panel 310 and the mounting surface 320.

Furthermore, the second fastening member includes at least one fastening pin 341. The fastening pin 341 is fastened in the mounting or mounting hole 322 formed in the mounting surface 320. The clip hook 332 is hooked around the fastening pin 341, and thus the panel 310 is coupled and fastened onto the mounting surface 320.

Referring to FIG. 12 (a), the mounting depression 322 is formed in the mounting surface 320 to have a predetermined depth. The mounting depression 322 is formed in one surface of the mounting surface 320. Referring to FIG. 12 (b), the mounting hole 322 is formed to pass through the mounting surface 320.

According to the third embodiment of the present invention, the shape of the mounting depression or mounting hole 322 may be selectively formed depending on the level of the shape, disposition structure, elasticity or the like of the clip hook 332. The content of the present invention is not limited by this shape.

Furthermore, Referring to FIG. 12, a plurality of fastening pins 341 and a plurality of mounting depressions or mounting holes 322 may be provided on the mounting surface 320, thereby fastening the panel 310 having one of various sizes onto the mounting surface 320.

Meanwhile, in the first fastening member shown in FIG. 11, the first fastening plate 331 and one end of the cutaway depression 312 may be coupled to each other in various structures. In FIG. 11 (a), the first fastening plate 331 and the one end of the cutaway depression 312 are coupled to each other by the elastic member 333 provided at the other end of the first fastening plate 331.

Accordingly, when seating and fastening the panel 310 onto the mounting surface 320 in case of necessity, a user ensures an available space between the clip hook 332 and the fastening pin 341 by pulling the first fastening plate 331 in one direction, thereby facilitating hook fastening.

Furthermore, in FIG. 11 (b), the first fastening plate 331 is rotatably coupled to one end of the cutaway depression 312 by a first rotating shaft 334 provided at the other end of the first fastening plate 331.

Therefore, in this case, when seating and fastening the panel 310 onto the mounting surface 320, a user ensures an available space between the clip hook 332 and the fastening pin 341 by rotating the first fastening plate 331 in one direction, thereby facilitating hook fastening.

Furthermore, one or more auxiliary clip hooks 332a may be provided at an end of the panel 310, preferably around the first fastening plate 331, and may be hooked around the fastening pin 341.

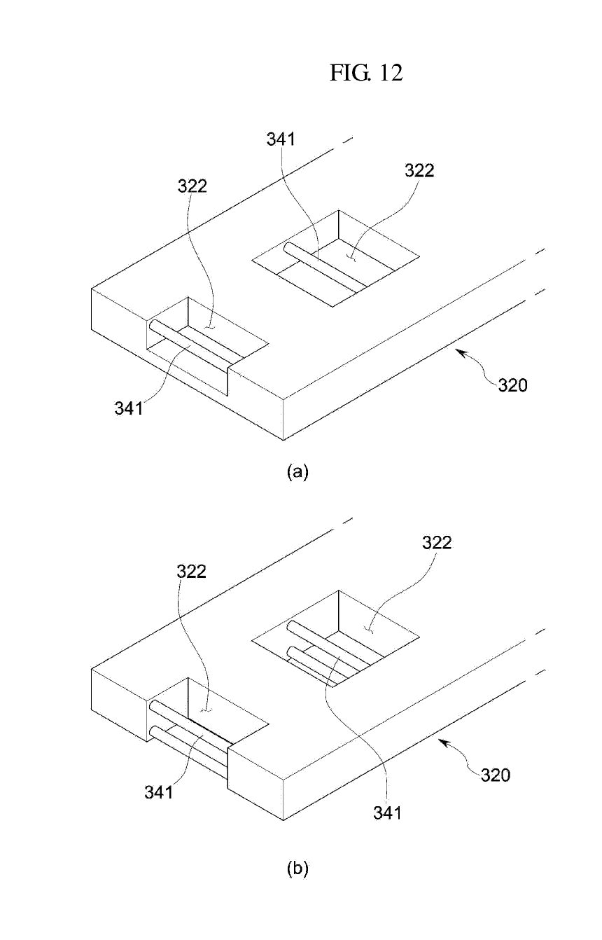

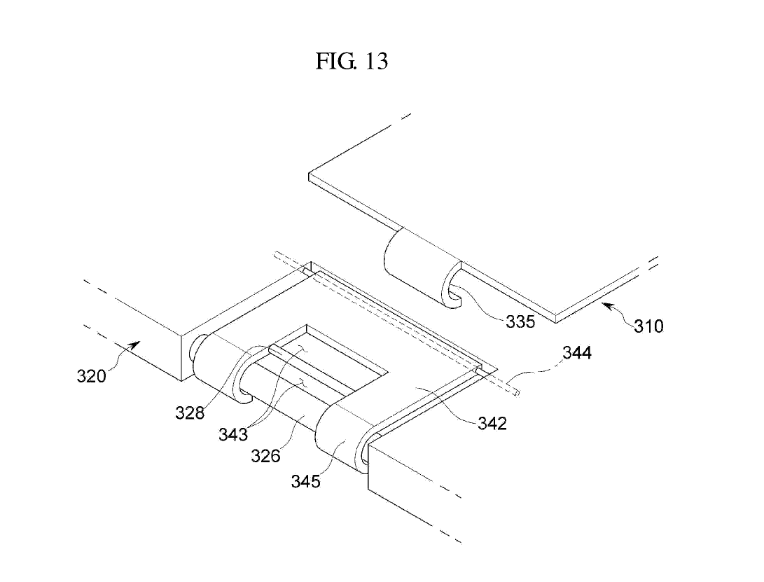

Meanwhile. FIGS. 13 and 14 are perspective views showing the fastening structure of the panel and mounting surface of the multifunctional panel assembly according to the third embodiment of the present invention.

Referring to FIGS. 13 and 14, the first fastening member is configured to include a first clip hook 335 provided at an end of the panel 310 in an integrated manner, and the second fastening member is provided on the mounting surface 320 and is configured to include a second fastening plate 342, a second rotating shaft 344, and a second clip hook 345. In this case, the clip hook 332 and the first rotating shaft 334 shown in FIGS. 11 and 12 correspond to the second clip hook 345 and the second rotating shaft 344 shown in FIGS. 13 and 14.

The second fastening plate 342 is provided with at least one opening 343 into which the first clip hook 335 can be hooked, and is provided to be separable from a cutaway depression 324 formed at an end of the mounting surface 320.

The second rotating shaft 344 is provided at the other end of the second fastening plate 342, and rotatably fastens the second fastening plate 342 into one end of the cutaway depression 324.

The second clip hook 345 is hooked around a first fastening pin 326 coupled to the other end of the cutaway depression 324.

The fastening process of the panel assembly including the first fastening member and the second fastening member is now described. First, the second clip hook 345 hooked around the fastening pin 326 is separated from the fastening pin 326, and the second fastening plate 342 is rotated toward the panel 310 and the first clip hook 335.

Furthermore, each of the first clip hooks 335 formed at both ends of the panel 310 is hooked around the second fastening pin 328 coupled in the opening 343 of the second fastening plate 342. Then, the second fastening plate 342 is rotated toward the first fastening pin 326, and the second clip hook 345 is hooked around the first fastening pin 326.

According to this fastening process, the panel 310 having an area identical to the area of the mounting surface 320 can be easily fastened onto the mounting surface 320 while maintaining strong fastening force.

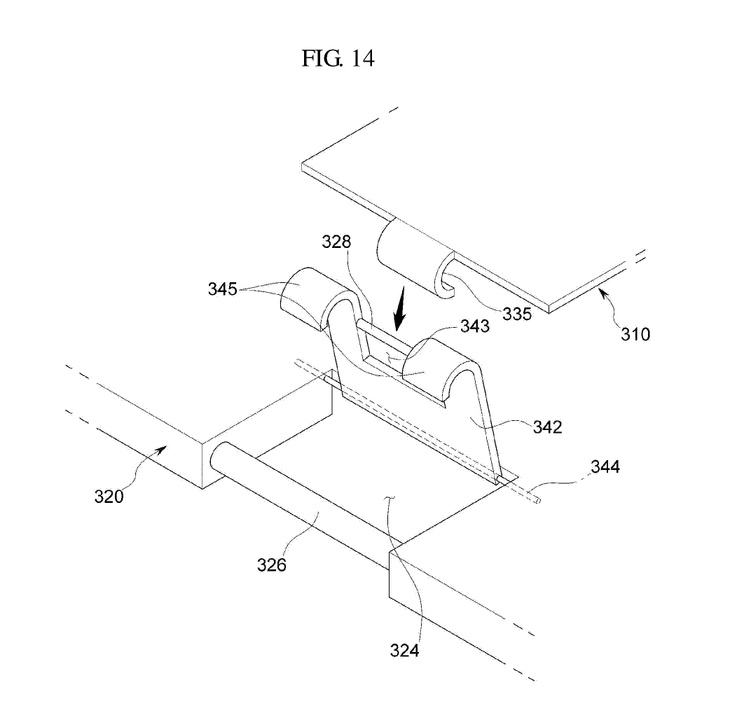

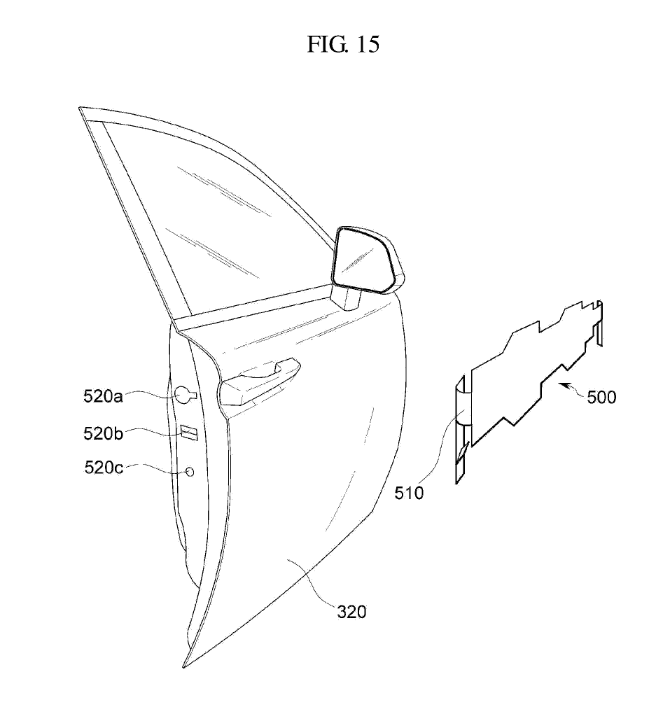

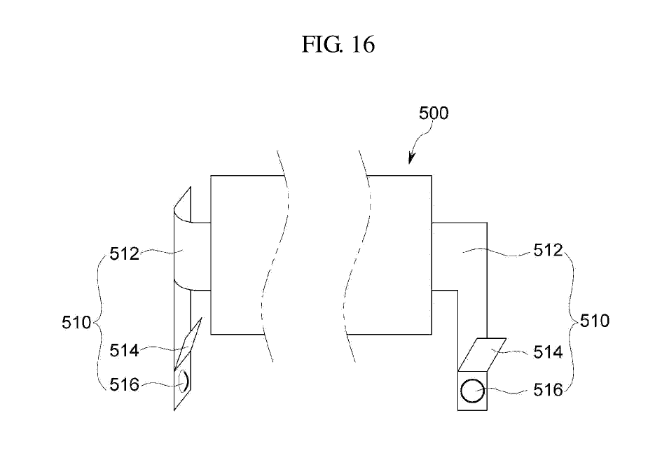

FIG. 15 is a diagram illustrating an example in which the mounting surface of a multifunctional panel assembly according to a fourth embodiment of the present invention is a side surface of a vehicle body, FIG. 16 is a diagram showing the panel of the multifunctional panel assembly according to the fourth embodiment of the present invention, and FIG. 17 shows sectional plan views showing various fastening structures of the mounting surface and panel of the multifunctional panel assembly according to the fourth embodiment of the present invention. Referring to FIGS. 15 to 17, the fastening structures of the panel and the mounting surface when the mounting surface of the multifunctional panel assembly is a side surface of a vehicle body will be described in detail.

The multifunctional panel assembly according to the fourth embodiment of the present invention includes a multifunctional panel 500, a mounting surface 320 configured such that the panel 500 is seated thereon, a fastening unit 510, a plurality of open portion 520a, 520b, 520c formed in the mounting surface 320, and a fastening rib 522.

According to this multifunctional panel assembly, when the multifunctional panel 500 is fastened onto the mounting surface 320 composed of a side surface of a vehicle body, the fastening unit 510 of the multifunctional panel 500 may be inserted and fastened into open portions 520a. 520b and 520c formed in a door of the vehicle body.

The fastening unit 510 is configured to include a fastening member 512, a hook member 514, and a protrusion member 516. The fastening member 512 is made of a material having elasticity and flexibility, and thus the fastening member 512 is introduced and fastened into the interior of the door through the open portions 520a, 520b and 520c, thereby fastening the panel 500 onto the mounting surface 320, i.e., an outside surface of the door of the vehicle body.

That is, the hook member 514 is hooked to a predetermined end inside the door, thereby enhancing the fastening force of the panel 500 and the mounting surface. In particular, the protrusion member 516 is inserted into the mounting surface, thereby fastening the panel 500 at an accurate location. In this case, it is preferred that the protrusion member 516 is made of a material having flexibility and some elasticity so as to provide contact force in connection with the mounting surface.

A fastening rib 522 is formed at an end in which the open portions 520a, 520b and 520c are formed. When the fastening member 512 is introduced into the open portion 520a, the fastening rib 522 supports the fastening member 512 while guiding it, thereby fixing the location of the panel 500. In this case, it is preferred that the fastening rib 522 is made of a material having rigidity as high as possible so as to enhance contact force in connection with the fastening member 512 and provide secure support.

For example, referring to FIG. 17 (a), the fastening member 512 is introduced into the open portion 520a, the hook member 514 is hooked into the open portion 520b, and the protrusion member 516 is inserted into the open portion 520c.

Furthermore, referring to FIG. 17 (b), the fastening member 512 is introduced into the open portion 520a and, simultaneously, the hook member 514 is hooked into the open portion 520a. The protrusion member 516 is inserted into the open portion 520b.

In this case, the hook member 514 is introduced into the open portion 520a, and follows the guidance of the fastening rib 522. Then, the hook member 514 is bent due to the elasticity and flexibility thereof, comes out through the open portion 520a or 520b, is restored into the original shape thereof, and is then hooked.

Meanwhile, as described above, according to the present invention, the panels 110, 210, 310 and 500 may be provided as panels having various functions, such as design, solar cell and display functions, etc.

That is, when one of all objects or items each having a mounting surface, including a transportation means including a vehicle, an electronic product, a building, etc., is designed, each of the panels 110, 210, 310 and 500 includes a decal, formed by printing, transferring, embossing or intaglioing a design of a desired character or shape, on at least one surface thereof.

Furthermore, when it is desired to provide various types of commercial image information so as to provide various types of information to drivers and passengers inside various transportation means, etc. or so as to provide an external advertising effect, each of the panels 110, 210, 310 and 500 is provided with a display device 420 for displaying images on at least one surface thereof.

In this case, it is apparent that it is preferred that each of the panel 110, 210, 310 and 500 is provided and equipped with a comprehensive image and sound acquisition and display device A including a camera, a microphone, a speaker, and related subsidiary equipment. Furthermore, it is preferred that subsidiary electronic equipment for acquiring, storing, transmitting and receiving related image data is further included.

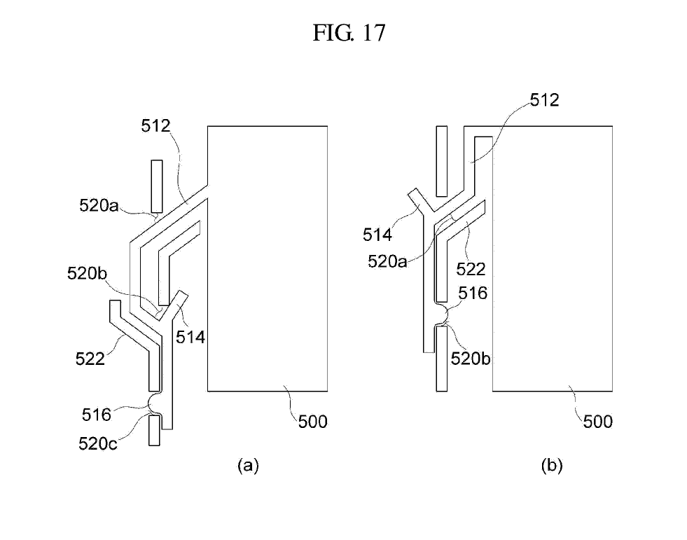

FIG. 18 is a perspective view showing a case where panels of a multifunctional panel assembly according to the present invention include display devices.

Referring to FIG. 18, there is shown a diagram illustrating an example in which panels 110, 210, 310 and 500, each including a display device 420 in which image and sound sensors and the like are embedded and mounted, are mounted by using the front, rear, left and right doors of a vehicle as mounting surfaces by means of the mounting structure of the multifunctional panel assembly according to the present invention, by means of at least one method of the mounting structure of the multifunctional panel assembly, welding, screw, bolt and nut fitting, an elastic clip. Velcro, an adhesive tape, and an adhesive pad, or by means of a combination of two or more of these methods.

In this case, image and sound information acquired by the image and sound sensors A of the panels 110, 210, 310 and 500 mounted on one side surface based on a reference in front of a driver's seat is transmitted and displayed to and on the panel 420, mounted on the other side, by means of vehicle-mounted image and sound data processing electronic equipment B via an electric wire or wireless communication.

In this case, a background image in one direction may be provided to an observer who is viewing a vehicle body in the direction. In an extended application, the panels 110, 210, 310 and 500 may be mounted on an overall vehicle by means of the mounting structure of the multifunctional panel assembly according to the present invention, by means of at least one method of the mounting structure of the multifunctional panel assembly, welding, screw, bolt and nut fitting, an elastic clip, Velcro, an adhesive tape, and an adhesive pad, or by means of a combination of two or more of these methods, and background image data in the observation direction may be directly displayed to the observer. Accordingly, a visually transparent vehicle in which only a background is seen by at least the observer and an actual vehicle is not seen by at least the observer may be configured.

Furthermore, when it is desired to provide the panels 110, 210, 310 and 500 on the roof of a house or an apartment building or the outside of a transportation means, such as a vehicle and generate power by using solar light or solar heat, each of the panels 110, 210, 310 and 500 includes the solar cell module 430 on at least one surface thereof.

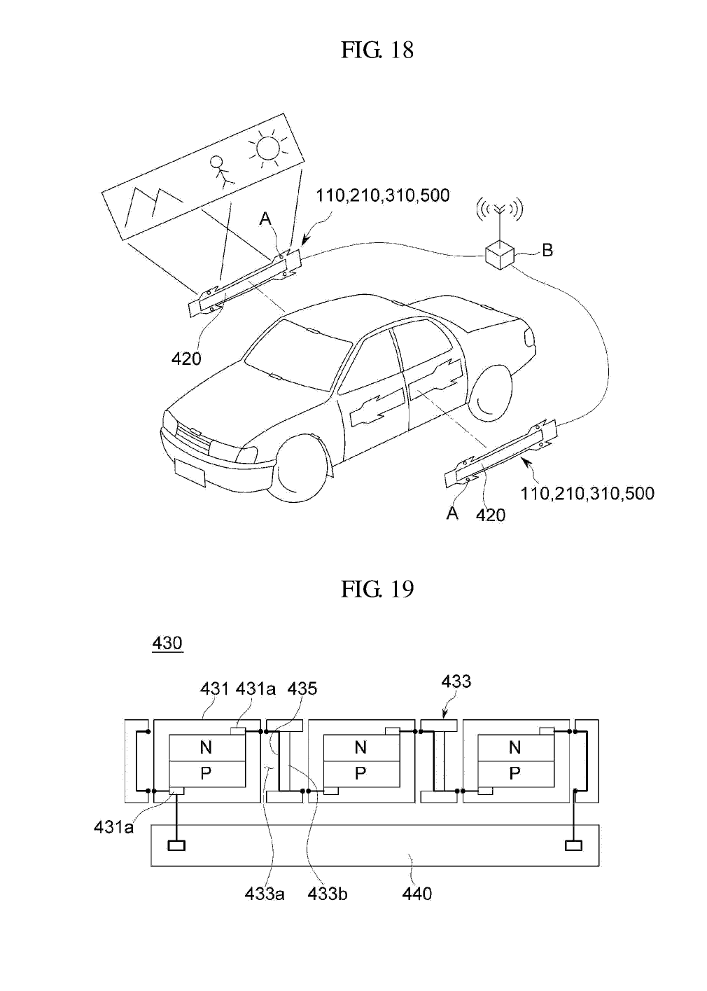

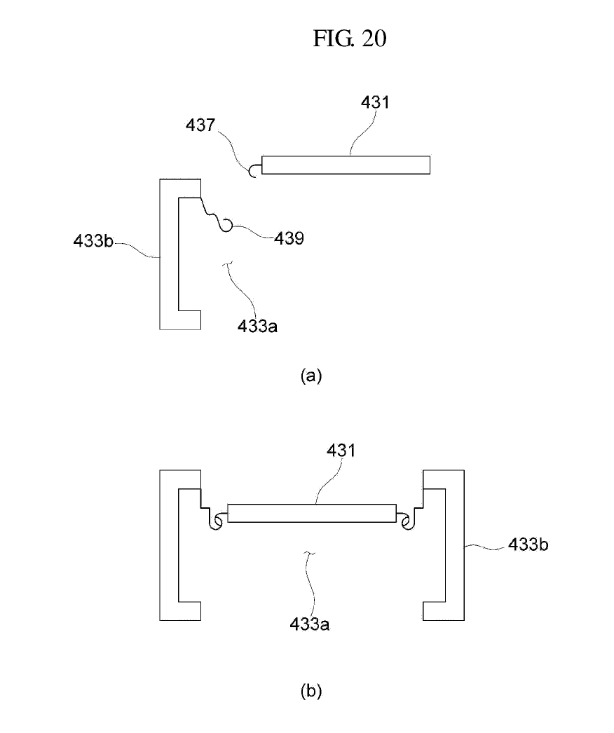

The specific structure of a multifunctional panel assembly in which each of panels 110, 210, 310 and 500 includes a solar cell module will be described in detail below with reference to FIGS. 19 and 20.

FIG. 19 is a sectional side view showing a case where panels of a panel assembly according to the present invention include solar cell modules, and FIG. 20 shows sectional side views schematically showing the solar cell mounting structure of the solar cell module shown in FIG. 19.

Referring to FIGS. 19 and 20, the solar cell module 430 includes a plurality of solar cells 431, a grid-type frame 433, connecting electric wires 435 embedded in the frame 433, and first hooks 437 and second hooks 439 made of an elastic material.

The solar cells 431 include a plurality of unit cells. The frame 433 is provided in the form of a grid so as to provide a plurality of mounting spaces 433a so that the solar cells 431 are inserted and fastened into the mounting spaces 433a.

The connecting electric wires 435 are embedded in the respective partitions 433b of the frame 433 defining the mounting spaces 433a, and are connected to terminals 431a provided in the solar cells 431. Accordingly, a user may configure the panels 110, 210, 310 and 500 each including the solar cell module 430 only by placing the solar cells 431 in the plurality of mounting spaces 433a.

Meanwhile, it is preferred that power generated in each of the multifunctional panel assemblies 110, 210, 310 and 500 including the frame 433 and the solar cell module 430 is stored in a battery 440 that is connected by an electric wire and provided at a different location.

The first hooks 437 are provided at both ends of the solar cell 431, and the second hooks 439 are provided at both ends of each of the partitions 433b and hooked to the fastening hooks 437. Accordingly, a user may conveniently mount the solar cells 431 in the mounting spaces 433a. In this case, the electric wires including first hooks 437 and second hooks 438 include the terminals of the embedded connecting electric wires 435, thereby forming the panels 110, 210, 310 and 500 each including the solar cell module 430 in which all electric wires are connected only by simple insertion mounting.

According to the present invention, each of the plurality of solar cells 431 may be modularized, and curvature may be applied to the panels 110, 210, 310 and 500 including the solar cell module 430. That is, even when the frame 433 is formed to have a curvature, the individual solar cells 431 may be easily mounted in the mounting spaces 433a.

Furthermore, even when part of the solar cells 431 has been damaged, the overall solar cell module 430 does not need to be replaced, and thus the ease of replacement is increased. The remaining undamaged solar cells 431 are used without change, and thus maintenance and repair costs can be significantly reduced.

In particular, it will be clearly appreciated by those having ordinary knowledge that the solar cell 431 may be mounted into the solar cell module 430 by means of the first hook 437, the second hook 439 and the mounting structure of the multifunctional panel assembly according to the present invention, which has been described in conjunction with the first to fourth embodiments, by means of at least one method of the former method, welding, screw, bolt and nut fitting, an elastic clip. Velcro, an adhesive tape, and an adhesive pad, or by means of a combination of two or more of these methods.

Although the examples in which the first to fourth embodiments are applied to a vehicle have been used for the technical description of the multifunctional panel assembly according to the present invention, technical problems that the present invention is intended to overcome are not limited to the above-described technical problems related to a vehicle. Although not described specifically, the present invention may be applied to all items and objects having inside and outside surfaces each having a specific shape, such as a partition, door, ceiling, and floor surface of a building and the body of a microwave oven. It will be clearly appreciated by those having ordinary knowledge that other technical problems related to the above applications are included in the spirit of the above-described technical problems that the present invention is intended to overcome.

While the embodiments according to the present invention have been described as described above, these embodiments are merely examples. It will be appreciated by those having ordinary knowledge in the art that various modifications and embodiments falling within an equivalent range may be made from the above description. Therefore, the true technical range of protection of the present invention should be defined based on the following claims.

1. A multifunctional panel assembly, comprising:
a multifunctional panel;
a mounting surface configured such that the multifunctional panel is seated thereon;
a fastening unit configured to be fastened onto a fastening surface adjacent to the mounting surface;
a connection portion configured to couple the multifunctional panel to the fastening unit; and
a grip portion provided on one end of the connection portion, and configured to grip the multifunctional panel.

2. The multifunctional panel assembly of claim 1, wherein the fastening unit comprises:
an introduction hole configured such that a remaining end of the connection portion is introduced thereinto; and
a fastening hole configured such that the remaining end of the connection portion introduced into the introduction hole is snap-fitted thereinto.

3. The multifunctional panel assembly of claim 2, wherein the connection portion comprises:
a flexible connection member made of an elastic or flexible material, and configured to be introduced into the introduction hole; and
a fastening hook provided at an end of the flexible connection member to be snap-fitted into the fastening hole.

4. The multifunctional panel assembly of claim 3, wherein the flexible connection member is introduced into the introduction hole formed in one end surface of the fastening unit, and the fastening hook is snap-fitted into the fastening hole formed in one surface or a remaining end surface of the fastening unit.

5. The multifunctional panel assembly of claim 3, wherein:
the introduction hole is formed in one end surface of the fastening unit;
the fastening hole is formed in a side surface of the fastening unit, and the introduction hole and the fastening hole communicate with each other so that the introduction hole and the fastening hole are inclined from the one end surface of the fastening unit to the side surface of the fastening unit; and
the flexible connection member is introduced into the introduction hole, and the fastening hook is snap-fitted into the fastening hole.

6. The multifunctional panel assembly of claim 1, wherein the grip portion is provided as a clip member configured to elastically press and grip the multifunctional panel, and a mounting depression or hole into which an end of the clip member is inserted is formed in the multifunctional panel.

7. A multifunctional panel assembly, comprising:
a multifunctional panel;
a mounting surface configured such that the multifunctional panel is seated thereon;
a pair of fastening units configured to be fastened onto a fastening surface, adjacent to the mounting surface, and the multifunctional panel, respectively; and
a connection portion configured to connect the pair of fastening units to each other.

8. The multifunctional panel assembly of claim 7, wherein each of the pair of fastening units comprises:
an introduction hole configured such that each of both ends of the connection portion is introduced thereinto; and
a fastening hole configured such that each of both ends of the connection portion introduced into the introduction hole is snap-fitted thereinto.

9. The multifunctional panel assembly of claim 8, wherein the connection portion comprises:
a flexible connection member made of an elastic or flexible material, and configured to be introduced into the introduction holes of the pair of fastening units; and
fastening hooks provided at both ends of the flexible connection member to be snap-fitted into the fastening holes of the pair of fastening units.

10. The multifunctional panel assembly of claim 9, wherein the flexible connection member is introduced into the introduction holes, wherein each of the introduction holes is formed in one end surface of each of the pair of fastening units, and each of the fastening hooks is snap-fitted into the fastening holes, wherein each of the fastening holes is formed in one surface or a remaining end surface of each of the pair of fastening units.

11. The multifunctional panel assembly of claim 9, wherein:
each of the introduction holes is formed in one end surface of each of the pair of the fastening units;
each of the fastening holes is formed in a side surface of the each of the pair of fastening units, and each of the introduction holes and each of the fastening holes in a same fastening unit communicate with each other so that they are inclined from the one end surface of the same fastening unit to the side surface of the same fastening unit; and
the flexible connection member is provided and is introduced into the introduction holes, and the fastening hooks are snap-fitted into the fastening holes.

12. A multifunctional panel assembly, comprising:
a multifunctional panel;
a mounting surface configured such that the multifunctional panel is seated thereon;
a first fastening member provided on an end of the multifunctional panel; and
a second fastening member provided on the mounting surface, and configured such that the first fastening member is fastened to the second fastening member so as to couple the multifunctional panel onto the mounting surface.

13. The multifunctional panel assembly of claim 12, wherein the second fastening member comprises at least one fastening pin coupled in a mounting depression or hole formed in the mounting surface; and the first fastening member comprises a first fastening plate separably provided in a cutaway depression formed at an end of the multifunctional panel, and a clip hook provided at one end of the first fastening plate and configured to be hooked around the at least one fastening pin.

14. The multifunctional panel assembly of claim 13, wherein the first fastening member further comprises an elastic member provided at a remaining end of the first fastening plate to connect the first fastening plate and one end of the cutaway depression to each other.

15. The multifunctional panel assembly of claim 13, wherein the first fastening member further comprises a first rotating shaft provided at a remaining end of the first fastening plate to rotatably couple the first fastening plate to one end of the cutaway depression.

16. The multifunctional panel assembly of claim 12, wherein:
the first fastening member comprises a first clip hook provided at the end of the multifunctional panel; and
the second fastening member comprises: a fastening plate separably provided in a cutaway depression formed at an end of the mounting surface, provided with at least one opening so that the first clip hook is hooked into the at least one opening, and provided with a second fastening pin coupled in the opening; a second rotating shaft provided at a remaining end of the fastening plate so as to rotatably couple the fastening plate into one end of the cutaway depression; and a second clip hook configured to be hooked around a first fastening pin coupled in a remaining end of the cutaway depression.

17. A multifunctional panel assembly, comprising:
a multifunctional panel;
a mounting surface configured such that the multifunctional panel is seated thereon;
a fastening unit provided at an end of the multifunctional panel, and configured to include a fastening member, a hook member, and a protrusion member;
a plurality of open portions provided in the mounting surface, and configured such that the fastening unit is mounted thereinto so as to couple the multifunctional panel onto the mounting surface; and
a fastening rib configured to guide the fastening unit that is introduced into the plurality of open portions.

18. The multifunctional panel assembly of claim 17, wherein the fastening member is made of an elastic or flexible material, the hook member is introduced and hooked into one of the plurality of open portions, and the protrusion member is inserted into one of the open portions.

19. The multifunctional panel assembly of claim 1, wherein at least one surface of the multifunctional panel is provided with a decal formed by printing or transferring a design of a desired character or shape.

20. The multifunctional panel assembly of claim 1, wherein at least one surface of the multifunctional panel is provided with a display device configured to acquire and display an image and a sound.

21. The multifunctional panel assembly of claim 1, wherein at least one surface of the multifunctional panel is provided with a solar cell module.

22. The multifunctional panel assembly of claim 21, wherein the solar cell module comprises:
a plurality of solar cells;
a grid-type frame configured to provide a plurality of mounting spaces into which the solar cells are inserted and fastened, respectively; and
connecting electric wires embedded in respective partitions of the frame defining the mounting spaces, and connected to terminals provided in the solar cells.

23. The multifunctional panel assembly of claim 22, wherein the solar cell module further comprises:
first hooks provided at both ends of each of the solar cells; and
second hooks provided at both ends of each of the partitions, and configured to be hooked to the first hooks.

24-26. (canceled)
